(19) United States
(12) Patent Application Publication
(10) Pub. No.: US 2010/0020844 A1
(43) Pub. Date: Jan. 28, 2010

(54) MONITORING SYSTEM

(75) Inventor: Robert Ashe, Fleet (GB)

Correspondence Address: DOBRUSIN & THENNISCH PC, 29 W LAWRENCE ST, SUITE 210, PONTIAC, MI, 48342, US

(73) Assignee: ASHE MORRIS LTD., Runcorn (GB)

(21) Appl. No.: 12/516,239

(22) PCT Filed: Nov. 19, 2007
(86) PCT No.: PCT/EP07/09970

§ 371 Date: May 26, 2009

(30) Foreign Application Priority Data
Nov. 27, 2006 (GB) 0623608.7

(51) Int. Cl. G01N 25/18

(52) U.S. Cl. 374/44

(57) ABSTRACT

The use for maintaining good equipment performance for heat transfer equipment which utilises real time heat transfer coefficient measurements to determine the thermal profile between the heat transfer fluid and the process fluid and this is used to maintain a safe operating temperature of the heating/cooling jacket.

This description applies to the measurement and use of heat transfer coefficients both in terms of one off measurements and continuous monitoring. The purpose of this is to provide heat transfer coefficient data in areas where it may be used in ways in which hitherto it has not been used. This includes the use of heat transfer coefficient data for developing better process methods, better equipment and better control strategies.

In this document, U value means the same thing as heat transfer coefficient (W/m²/K⁻¹).

In this document, the term ‘real time’ has been used. This implies that events occur or are made to occur instantly or analytical data is observed instantly. In reality, there is always a delay due to lags in the system. In practice, a ‘real time’ response or observation might be expected to involve a delay of less than 10 seconds (or preferably less than 1 second). This is however not always the case and in some circumstances, ‘real time’ may involve a delay of a minute or even longer. Alternatively, the delays may have more than one time frame. For example, a change in an observed heat load may be measured within less than 10 seconds but it may take more than 30 seconds to quantify the new load.

Fouling is a phenomenon encountered in many types of liquid handling, processing or storage applications, particularly liquid applications. Fouling occurs when a material deposits on a surface. The causes of fouling may be chemical, physical or biological in origin.

This document relates to processes and process equipment which use some form of heat exchanger. In some cases, the heat exchanger may only be used for the purpose of monitoring heat transfer coefficient.

The present invention is applicable to many types of system where fouling is encountered. Some examples include continuous reactors, batch reactors, food process machinery, evaporators, dryers, granulators, industrial heating and cooling systems etc. It also applies to many types of industry such as oil production and refining, chemical, petrochemical, water treatment and pharmaceutical manufacturing processes, minerals processing, food etc. It is also applicable to many other types of heat exchanger such as water heating/cooling systems, engines etc.

This technology can also be used to improve processes that do not suffer from fouling problems. This includes monitoring changes in the process material (e.g. product viscosity), monitoring equipment design (e.g. vessel shape) or equipment setup (e.g. agitator speed). In all of these cases, there are often relationships between these parameters and heat transfer coefficient.

Fouling can occur on any surface but the presence of heating can promote or make fouling more difficult to contend with. In other circumstances the fouling can be promoted by cooling where by product precipitates on to the cooling surface as solids or crystals.

The problems caused by fouling are handled in a variety of different ways. Some of these involve cleaning strategies or relate to the chemicals used in cleaning. In other cases, prevention measures are used to avoid fouling in the first place. This can involve such methods as the use of chemical additives or maintaining a minimum level of agitation or liquid velocities.

Fouling on heat transfer surfaces is undesirable for a number of reasons. It reduces the heat transfer capacity of the heat exchanger. It can cause damage to the heat transfer equipment. It causes downtime of the process equipment. It can be costly to clean. In some cases, the fouling can lead to the release of undesirable chemicals or particulates into the product.

Fouling can be a particular problem when associated with hot surfaces. Consider a tank being used to heat milk. Surrounding the tank is a heating jacket through which hot steam flows. The metal surface in contact with the milk is kept cool by the cold milk being stirred within the tank. If a film of milk starts to deposit on the metal surface, this represents fouling. This layer of fouling insulates the metal surface from the cooling effect of the milk. The result is that the metal surface gets hotter. As it gets hotter, any material adhering to the surface also gets hotter. For temperature sensitive products like milk, the high temperature causes chemical and/or physical changes in the deposit. This can lead to the fouled material becoming baked onto the surface. Material affected by the extreme temperatures may also be released back into the process material thereby contaminating or tainting it. The fouled material may also break away in the form of particulates. As the fouling gets worse, the more difficult it can become to remove.

This document describes a method for controlling and managing fouling problems in systems involving heat transfer by monitoring the heat transfer coefficient. There are two benefits to this method. Firstly, if the heat transfer coefficient can be continuously monitored, the user can identify those conditions which foster rapid fouling and thereby avoid or minimise them. The second benefit is that by monitoring the heat transfer coefficient the user can monitor fouling and use this information to prevent or manage the fouling problem better.

The heat transfer coefficient (U) is calculated from the following equation:

q=U×A×LMTD (W) (1)

### Where

q=heating or cooling rate of the heat exchanger (W)
U=heat transfer coefficient (W.m⁻².K⁻¹)
A=heat transfer area (m²)
LMTD=temperature difference between cooling/process fluid (K)

In order to measure the heat transfer coefficient, it is necessary to determine the quantity of heat (q) being added or removed by the heat exchanger. The preferred method of measuring this is based on measuring the heat gained or lost by the heat transfer fluid. This can be achieved by measuring the mass flow rate, inlet temperature and outlet temperature of the heat transfer fluid and calculating as follows:

q=m×Cp×(tᵢₙ−tₒᵤₜ) (W) (2)

### Where

q=heating or cooling rate of the heat exchanger (W)
M=mass flow of the heat transfer fluid (kg/s)
Cp=specific heat of the heat transfer fluid (J)
(tᵢₙ−tₒᵤₜ=temperature shift of the heat transfer fluid (K)

By measuring the heat (q), heat transfer area (A) and log mean thermal difference (LMTD) the value of U can be calculated from equation (1). In systems which regulate heating or cooling power by varying the heat transfer area, the heat transfer area (A) will need to be monitored continuously. This can be achieved by monitoring the position of the device controlling the variable area (a valve may be used to vary the area) and using this information to calculate the heat transfer area. These activities can be computerised in order to obtain real time monitoring.

Other methods can be used for measuring the U value. For example, q could be measured by monitoring a different parameter (such as product temperature change in a heater with a continuously flowing product). Another example would be to measure the flow of condensate in a steam heated system.

Although many types of system can use this technique, the preferred equipment for monitoring the U value are systems which use ‘reduced volume jackets’ as described in PCT publication number WO 2004/017007. Even more preferred are systems which use variable area as a control parameter for regulating heating or cooling power as described in PCT publication number WO 02/087752.

In some cases, the U value can be measured accurately. This information will allow the user to quantify the film resistance at the metal/process interface as follows:

1/U·A=1/(h_{htf}·A_{htf})+L_{c}/k_{c}·A_{c}+Lₚ/kₚ·Aₚ+1/(hₚ·Aₚ) (K·W⁻¹) (3)

### Where

UA=nominal heat transfer capacity per Kelvin (W.K⁻¹)
h_{hft}=heat transfer fluid coefficient (W.m². K⁻¹)
A_{hft}=heat transfer area of the internal conduit wall (m²)
L_{c}=thickness of the conduit wall (m)
k_{c}=thermal conductivity of the conduit wall (W.m⁻¹.K⁻¹)
Aₚ=Contact area between the conduit and the process wall (m²)
Lₚ=thickness of the process wall (m)
kₚ=thermal conductivity of the process wall (W.m⁻¹.K⁻¹)
Aₚ=Area of the process wall (m²)
Hₚ=Process material heat coefficient (W.m⁻².K⁻¹)

The reference to conduit is based a cooling jacket made up of pipes fixed to the outside of the vessel walls. Other designs of jacket could use other variations on this equation.

The values of A, Aₚ, (h_{htf}.A_{htf}), (L_{c}/k_{c}.A_{c}) and (Lₚ/kₚ.Aₚ) can be predetermined by a variety of measurements and tests under standard conditions. The heat transfer coefficient (U) is measured by the method described before. Thus by knowing all these factors, hₚ can be determined. By using the information on film coefficients, thermal conductivities and wall thicknesses, the temperature profile between the heat transfer fluid and process material can be determined. This will allow users to maintain safe operating temperatures (from the perspective of preventing product damage) for the heating/cooling jacket. A safe operating temperature in this context describes a temperature which does not expose the product to surface temperatures of the heat transfer surface which could thermal damage (hot or cold) to the product or could cause unwanted process changes (surface freezing, boiling or unwanted nucleation in crystallisation)

This document applies to both U value snapshot measurements and U value monitoring. The advantage with monitoring over snapshot measurements is that the relationship between U value and process variables can be better understood for improving understanding and/or control of the process.

It should be recognised that, in many instances, the absolute value of U in terms of W.m⁻².K⁻¹ may not be required. The two factors of interest may be the U value in relation to some reference value (e.g. the U value of a clean surface), and the rate of change of the U value.

The value of U (in relation to a reference value) can be used as a tool for monitoring fouling. By having ‘real time’ monitoring of the U value the plant operator can stop the process before fouling becomes difficult to clean or affects process performance. The fouling detector could, where necessary, trigger an alarm to warn the operator of low U values. It is also possible to set up automated fouling prevention measures such that the U value data is used in real time to prevent fouling, reduce the rate of fouling or initiate a cleaning sequence.

The U value monitoring can also be used to regulate the heating/cooling jacket temperature. For example, to avoid fouled material accumulating on to the vessel surface, a heating jacket temperature could be progressively reduced as the fouling becomes more serious. In many instances such a control measure could prevent rapid slow down of heating or cooling due to fouling. It could also reduce the problems of product contamination or cleaning.

The rate of change of the U value provides a tool for identifying favourable operating conditions. A more rapid fall in the U value signifies a more rapid build up of fouling. With U value monitoring, the plant operator has the ability to see in real time the relationship between different process variables (process temperature, heat transfer fluid temperature, agitation rate etc) and the rate of build up of fouling. An accelerated fall in the heat transfer coefficient warns the user that one or more of the process variables is operating under sub optimal conditions (from a fouling perspective). The fouling rate detector could, where necessary, trigger an alarm to warn the operator of an unacceptable rate of decline in the U value. It could also be used to provide feed back control of critical process variables such that the variable in question is controlled such that the rate of fouling is constant or follows an acceptable trajectory.

In some cases, a change in the U value may not be due to fouling but to changes in the film coefficient. In these cases, the U value can be used to monitor the relationship between the film coefficient and the process variable (process temperature, heat transfer fluid temperature, agitation rate, viscosity etc). This enables the plant operator to develop operating methods and equipment designs that maximise the heat transfer coefficient. This would permit plant operators to identify the ideal design and speed of an agitator. In the case of scraped film systems, the U value could be used to set up the clearance of the blade and it could also monitor the condition of the material between the blade and the wall of the vessel.

In some cases U value monitoring can be used to differentiate between fouling and film coefficient (hₚ). For this, another factor needs to be evaluated. For example, consider a process where the viscosity is changing and fouling can take place as well. To calibrate this system, the relationship between viscosity and the U value needs to be established first. This can be done be taking U value measurements under non-fouling conditions and relating U value to parameters like agitator speed and torque. This will provide a base line curve. By monitoring these same parameters in the process, the system can predict the expected U value. Where this U value is lower than predicted, the difference will be fouling.

Where variable area systems are used the use of a variable area control valve is preferred where systems are required to measure or monitoring the U values. The operation of this valve is described in PCT publication number WO 03/018187.

This technology can be applied to the measurement and monitoring of the U value on systems of 1 litre and smaller. The use of ‘reduced volume jackets’ is suitable for such systems. More preferably, the use of variable area control of the heat transfer surface is desirable for such systems. This would be valuable for development work to determine better process methods and better process control.

This technology can also be applied to the measurement and monitoring of the U value on systems of 1 litre and larger. The use of ‘reduced volume jackets’ is suitable for such systems. More preferably, the use of variable area control of the heat transfer surface is suitable for such systems. This would be valuable for development work to determine better process methods and better process control.

This technology can also be applied to the measurement and monitoring of the U value on systems of 10 litre and larger. The use of ‘reduced volume jackets’ is suitable for such systems. More preferably, the use of variable area control of the heat transfer surface is suitable for such systems. This would be valuable for development work to determine better process methods and better process control.

This technology can also be applied to the measurement and monitoring of the U value on systems of 100 litres and larger. The use of ‘reduced volume jackets’ is suitable for such systems. More preferably, the use of variable area control of the heat transfer surface is suitable for such systems. This would be valuable for development work to determine better process methods and better process control.

This technology can also be applied to the measurement and monitoring of the U value on systems of 1000 litres and larger. The use of ‘reduced volume jackets’ is suitable for such systems. More preferably, the use of variable area control of the heat transfer surface is suitable for such systems. This would be valuable for development work to determine better process methods and better process control.

This technology can also be applied to the measurement and monitoring of the U value on systems of 10000 litres and larger. The use of ‘reduced volume jackets’ is suitable for such systems. More preferably, the use of variable area control of the heat transfer surface is suitable for such systems. This would be valuable for development work to determine better process methods and better process control.

Measurement or monitoring of the U value can be used for jacketed vessels such as industrial batch reactors or batch dryers.

Measurement or monitoring of the U value can be used for vessels with internal heat transfer coils.

Measurement or monitoring of the U value can be used for continuous batch processes.

Measurement or monitoring of the U value can be used for systems where the heat transfer fluid does not change phase (vapour to liquid or liquid to vapour).

Measurement or monitoring of the U value can be used to ensure optimum timing of vessel cleaning cycles.

Measurement or monitoring of the U value can be used for real time monitoring of the U value so as to improve processing methods or equipment, particularly in the food industry.

Measurement or monitoring of the U value can be used for processes whereby a parameter (for preventing or removing fouling) is controlled according to the observed U value which is being monitored in real time or at intervals.

Measurement or monitoring of the U value can be used for processes whereby the heating or cooling flux is controlled according to the observed U value which is being monitored in real time or at intervals.

Measurement or monitoring of the U value can be used for processes whereby the addition rate of a chemical (for preventing or removing fouling) is controlled according to the observed U value which is being monitored in real time or at intervals.

Measurement or monitoring of the U value can be used for processes whereby the temperature of the heat transfer fluid is controlled according to the observed U value which is being monitored in real time or at intervals.

Measurement or monitoring of the U value can be used for processes whereby the heating or cooling power is controlled according to the observed U value which is being monitored in real time or at intervals.

Measurement or monitoring of the U value can be used for processes whereby the rate of agitation or mixing or scraping is controlled according to the observed U value which is being monitored in real time or at intervals.

Measurement or monitoring of the U value can be used for food manufacturing processes.

Measurement or monitoring of the U value can be used for water treatment processes.

Measurement or monitoring of the U value can be used for organic chemical manufacturing processes.

Measurement or monitoring of the U value can be used for inorganic chemical manufacturing processes.

U value measurement or monitoring can be used to identify preferred designs and speeds of agitator.

U value measurement or monitoring can be used to monitor changes to heat exchanger surfaces (such as rusting).

U value measurement or monitoring can be used to monitor erosion or corrosion. This is because the U value increases where the wall thickness of the heat exchanger gets thinner.

1-21. (canceled)

22. A method for monitoring and controlling the state of heat transfer equipment comprising a vessel for process fluid and a plurality of conduits for heat transfer fluid and means for varying the number of said conduits for heat transfer fluid in operation, the temperature of the heat transfer fluid entering the conduits (tin) is measured and the temperature of the heat transfer fluid leaving the conduits (tout) is measured and the flow rate of the heat transfer fluid is measured and the heat (q) passing between the heat transfer fluid and the process fluid is determined according to the equation q=m×Cp×(tin−tout) and this is used to determine the heat transfer coefficient (U) from the equation q=U×A×LMTD where A is the area of contact between the conduits carrying heat transfer fluid and the process vessel, and using the heat transfer coefficient or information derived from the heat transfer coefficient to monitor and control the system.

23. A method according to claim 22 wherein the heat transfer coefficient is used to monitor the heat transfer surface for fouling.

24. A method according to claim 22 wherein the heat transfer coefficient is used to detect boiling of the process fluid.

25. A method according to claim 22 wherein the heat transfer coefficient is used to detect a change in the viscosity of the process fluid.

26. A method according to claim 22 whereby the heat transfer coefficient is used to determine the temperature of the heat transfer surface in contact with the process fluid to regulate the jacket temperature.

27. A method according to claim 22 where the vessel has a single valve for varying the number of conduits in operation and thus the heat transfer area.

28. A method according to claim 22 where the vessel has multiple valves for varying the heat transfer area.

29. A method according to claim 22 performed in a batch reactor.

30. A method according to claim 22 comprising a food manufacturing process.

31. A method according to claim 23 comprising a food manufacturing process.

32. A method according to claim 22 whereby the rate of agitation or mixing or scraping of the vessel is controlled according to the calculated U value.

33. A method according to claim 22 whereby the addition of a chemical to the process fluid is determined according to the observed U value.
